(19) United States
(12) Patent Application Publication
(10) Pub. No.: US 2007/0280135 A1
(43) Pub. Date: Dec. 6, 2007

(54) Apparatus and method for monitoring status of a network element

(75) Inventors: Mehrab Syed, Kanata (CA); Dai Truong, Kanata (CA); Georges Chung Kam Chung, Ottawa (CA); John Fischer, Stittsville (CA)

Correspondence Address: Arnold B. Silverman;Eckert Seamans Cherin & Mellott, LLC, 44th Floor, 600 Grant Street, Pittsburgh, PA, 15219, US

(73) Assignee: Alcatel, Paris (FR)

(21) Appl. No.: 11/444,676

(22) Filed: Jun. 1, 2006

(51) Int. Cl. H04L 12/28

(52) U.S. Cl. 370/254; 370/252

(57) ABSTRACT

An apparatus and method for monitoring a status of a network element in a communication network is provided. The apparatus includes an interface for transmitting status requests for the network element and receiving status information from the network element, and a controller for controlling transmission of the status requests. The controller is responsive to a status report confirming reachability of the network element, or to a transition from a reachable state, in which the reachability of the network element is valid, to a probe state, to transmit a status request to the network element to reconfirm its reachability status.

### FIELD OF THE INVENTION

The present invention relates to apparatus and methods for monitoring status of a network element, and in particular, but not limited to apparatus and methods for monitoring reachability of a network element.

### BACKGROUND

In communication networks, methods are implemented for enabling nodes to determine information about neighboring nodes to which they are connected to maintain a record of this information and to track changes as they occur. One such method is “neighbor discovery” used in IPv6 (Internet Protocol Version 6) communication systems, and involves the exchange of specific messages between network nodes. The messages include “neighbor solicitation” messages which are addressed to a target node and may include the link layer address of the source node, and “neighbor advertisement” messages which are either sent in response to neighbor solicitation messages or periodically. Neighbor advertisement messages typically contain a link layer address by which the node can be reached and other information that may be used by neighboring nodes, including suggested settings for various parameters.

IPv6 compliant nodes also use neighbor solicitation and neighbor advertisement messages to monitor the reachability of neighboring nodes and to maintain a record of each neighbor's reachability, which is typically recorded in a neighbor cache. Referring to FIG. 1, to determine the reachability of a target node, the source node 1 transmits a neighbor solicitation message 3 to the target node 5, which responds by returning a neighbor advertisement message 7. Receipt of the neighbor advertisement message 7 by the source node 1 confirms that the target node is reachable and the source node enters this information in its neighbor cache 9. A dynamically variable status is associated with each entry in the neighbor cache and depends on the length of time since the reachability of the target node was last verified. In one implementation, the router advertisement message sent by the target node may specify a period of time that the source node can assume the target node to be reachable. The source node uses this time period to set a timer for the relevant neighbor cache entry and the timer counts over the set period. While the time is within the set period, the entry status indicates that the node is “reachable”, and once the time has expired, the entry status transitions to “stale” which indicates that the reachable time has expired. Neighbor cache entry states as defined in RFC2461 for IPv6 (Internet Protocol Version 6) is described in more detail below with reference to FIG. 2.

Referring to FIG. 2, where a neighbor is being contacted but the cache entry does not yet exist, the entry status is “incomplete” while multicast neighbor solicitation(s) are sent. When a unicast neighbor advertisement message is received in response to a neighbor solicitation, reachability of the node is confirmed and the status of the cache entry indicates “reachable”, and remains in this state for a period of time specified in the router advertisement message or until a host default value has elapsed. If upper layer protocols indicate that the node is still reachable, each indication causes the time governing the reachable status to be refreshed. If the reachable time (i.e. the time since the last reachability confirmation was received) has elapsed, the entry status becomes “stale”, and the entry remains in the stale state until a packet is sent to the neighbor. When a packet is sent in the “stale” state, the status changes to a “delay” state for a predetermined period of time (e.g. 5 seconds) to provide upper layer protocols the opportunity to confirm whether the neighbor is reachable. If the delay time expires before such confirmation is detected, the entry status changes to a “probe” state in which a series of unicast neighbor solicitations are sent to the node. If a solicited neighbor advertisement is received, the entry returns to the “reachable” state, otherwise the entry is removed, as indicated by the “no entry exists” state.

As indicated above, in order to implement an IPv6 neighbor cache and perform the state transitions described in RFC2461, a system must be able to detect traffic flow on neighbor cache entries in the “stale” state to enable a transition from the “stale” state to the “delay” state. This detection must be performed without loss of traffic or packet re-ordering, and this generally requires special hardware support. For example, as shown in FIG. 3A, a special detector may be implemented for detecting data flow for each neighbor. However, many hardware platforms are not capable of this, and therefore an alternative approach must be used.

An alternative is to implement a software or firmware based solution. In this solution, the software removes the neighbor cache entry from the fast data path when its reachability timer expires, and the entry transitions from the “reachable” to the “stale” state. As shown in FIG. 3B, removal of the neighbor cache entry from the fast data path forces any data traffic for the entry to be transferred from the fast data path to the software based control path (i.e. the slow path). Thus, when traffic flows on the entry, the software captures (and thereby detects) the traffic, causing the entry to change to the “delay” state, reprograms the fast data path (by adding the cache entry back into the fast path) so that traffic can flow, and re-inserts the packet(s) from the slow path into the fast path, as shown by the broken line path in FIG. 3B. After the delay timer expires, neighbor reachability is re-tested in the “probe” state.

For this solution to work satisfactorily in multiple high speed interfaces, extremely high performance of the slow-path software is required. However, there are many situations, in which, for example, traffic includes large numbers of data packets and/or has high packet rates, where the probability of losing packets or re-ordering packets is high. Loss of data packets may for example occur as a result of limitations in buffering data passed to the slow path, and loss and/or reordering of data packets may occur when transferring captured packets back into the fast path while re-enabling the fast path to carry traffic. This may be particularly problematic for traffic containing media data where any reordering or loss of video packets perceptibly compromises the quality of service.

### SUMMARY OF THE INVENTION

According to the present invention, there is provided an apparatus for monitoring status of a network element in a communication network, comprising: transmission means for transmitting a status request, receiving means for receiving a status report containing status information, and a controller for controlling transmission of a status request at least one of (1) in response to the receipt of said status report, (2) during a time period when said status information contained in the received status report is deemed to be valid, and (3) in response to the expiry of said time period.

In this arrangement, the controller is responsive to a status report to control the transmission of a status request. For example, where a status report indicates that a network element (or interface thereof) is reachable, the reachability indication causes the controller to automatically transmit a status request, which may again request confirmation from the network element that the network element is reachable. This enables a status request to be transmitted following receipt of a status report irrespective of the use of an attribute to which the status report relates. For example, this arrangement avoids the need for detecting data flow on the respective data path required by the current implementation of IPv6 in order to transition from the “stale” state to the delay state and then to the “probe” state, which only then allows a status request to be transmitted. Thus, in the present arrangement, the transmission of a status request overrides and is independent of any data flow on a respective data path. In other words, receipt of a status report is sufficient to trigger the transmission of a status request.

The controller is adapted to control transmission of a status request in response to the receipt of a status report. In one embodiment, the controller may be adapted to transmit a status request on receipt of a status report or may await a predetermined period of time, for example, during which the status report is deemed to be valid, and send the status request either during that time period or in response to the expiry of that time period. (The time period over which the status is deemed to be valid is limited and on expiry, the status can no longer be deemed to be valid.) Following receipt of the status report, information confirming the status indicated in the report may be received from one or more other sources, which may thereby extend the time period over which the status information is deemed to be valid. In some embodiments, the controller is responsive to the expiry of a predetermined time period from which the last indication is received confirming the status information of the status report to cause transmission of the status request.

In some embodiments, the controller may be implemented by or responsive to a state machine having a state which indicates that status in a status report is deemed to be valid, and another state which directly follows and causes or enables transmission of a status request. The second state may include a delay which controls the timing of transmission of a status request when a state changes to the second state, but once the second state is entered, transmission of a status request is deterministic.

In some embodiments, the status comprises a status indicative of whether the network element is reachable.

In some embodiments, the controller is adapted to cause transmission of the status request a predetermined period of time after one of (1) the status report is received, and (2) a last indication is received confirming the status information contained in the status report.

In some embodiments, the status report includes the status for a predetermined attribute associated with the network element and the status request includes a request for the status of the same attribute.

In some embodiments, the transmission means is adapted to transmit the status request as a unicast transmission.

In some embodiments, the transmission means is adapted to transmit a further status request subsequent to the previous status request according to a selected transmission mode, depending on the response of the network element to the status request. For example, in one embodiment, the transmission mode is a unicast transmission if a status report received in response to the status request indicates that the network element is reachable, and the transmission mode is a multicast transmission if it is determined that the network element, in response to the status request, is unreachable.

In some embodiments, the controller is adapted to cause the transmission means to transmit a status request in response to the receipt of each status report from the network element that is responsive to a previous status request, and which indicates that the network element is reachable, and to transmit each status request at least one of (1) a predetermined period of time after the receipt of a respective status report, (2) during a time period when the status information is deemed to be valid, and (3) in response to the expiry of the time period. The predetermined time period may for example be a time period over which the network element is assumed to be reachable.

In some embodiments, the controller comprises a timer for measuring the predetermined time, and which is activated by at least one of (1) the receipt of a status report indicating that the network element is reachable, and (2) a determination that the network element is reachable.

In some embodiments, the controller causes transmission of the status request immediately after the timer indicates that the predetermined time period has expired, or as a direct consequence of such an indication.

In some embodiments, the apparatus further comprises a memory for storing information about the network element, and indicating means for indicating a state associated with the information, the indicating means indicating a state indicative of the network element being reachable in response to the receipt of a status report from the network element, and for indicating a state immediately after expiry of the time period which is indicative of the transmission of a status request.

In some embodiments, the status request is a neighbor solicitation message.

In some embodiments, the status report is a neighbor advertisement message.

In some embodiments, the apparatus may be used to implement an IP (Internet Protocol) based communication system.

In some embodiments, the apparatus may be used to implement an IPv6 (Internet Protocol Version 6) based communication system.

In some embodiments, the apparatus may be used to implement a neighbor discovery process.

Also according to the present invention, there is provided a method of monitoring status of a network element in a communication network, comprising: receiving a status report containing status information from said network element, and transmitting a status request to said network element at least one of (1) in response to the received report, (2) during a time period when said status information is deemed to be valid, and (3) in response to the expiry of said time period.

According to the present invention, there is further provided an apparatus for monitoring status of a network element, comprising a transmitter for transmitting a status request for the network element, a receiver for receiving status information about the network element and a module for controlling a state of the apparatus, the module being operable to switch from a state indicative of the status information directly to another state which enables the transmitter to transmit a status request.

In one embodiment, the status information may indicate that the network element is reachable. The module may be adapted to automatically switch from the one state to the other state when the status information, for example reachability of the network element, can no longer be deemed valid. Advantageously, this arrangement allows a transition from a “reachable” state to a “stale” state to be avoided, by instead transitioning to a state in which a status request is sent to reconfirm the network element's reachability, and thereby prevents packet loss and/or reordering which would otherwise be caused by a transition to the “stale” state.

According to the present invention, there is further provided an apparatus for recording the status of a network element, comprising: a recorder for entering an identification of said network element in a record, said recorder being responsive to a message from said network element to assign a first state to said record indicating that said network element is reachable, said recorder being responsive to said message and/or to the expiry of a time period following receipt of said message during which information in said message is deemed to be valid, to assign a second state to said record indicating that a status request is being sent to said network element.

### BRIEF DESCRIPTION OF THE DRAWINGS

Examples of embodiments of the present invention will now be described with reference to the drawings in which:

FIG. 1 shows a block diagram of communication network nodes exchanging neighbor discovery communications according to the prior art;

FIG. 2 shows a block diagram of the possible states associated with neighbor cache entries for IPv6 neighbor discovery, according to the prior art;

FIG. 3A shows a schematic diagram of an interface according to the prior art;

FIG. 3B shows a schematic diagram of another interface according to the prior art;

FIG. 4 shows a network element according to an embodiment of the present invention;

FIG. 5 shows an example of states for neighbor cache entries according to an embodiment of the present invention; and

FIG. 6 shows a flow diagram of a method for monitoring status of a network element according to an embodiment of the present invention.

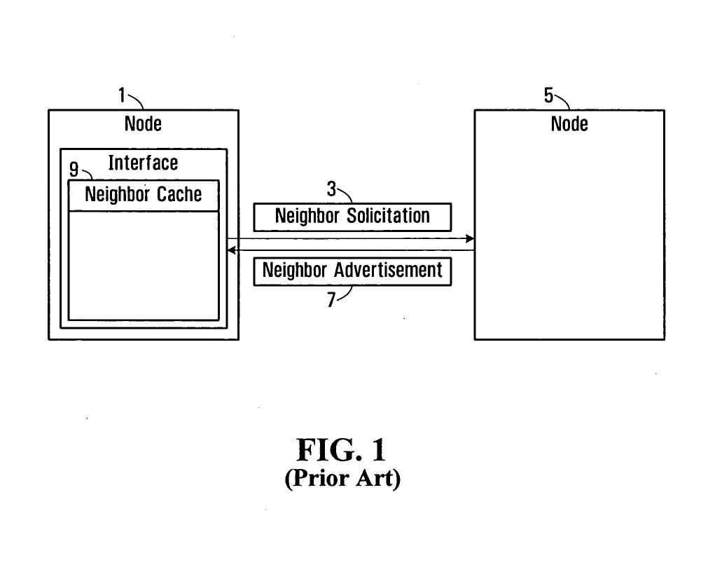

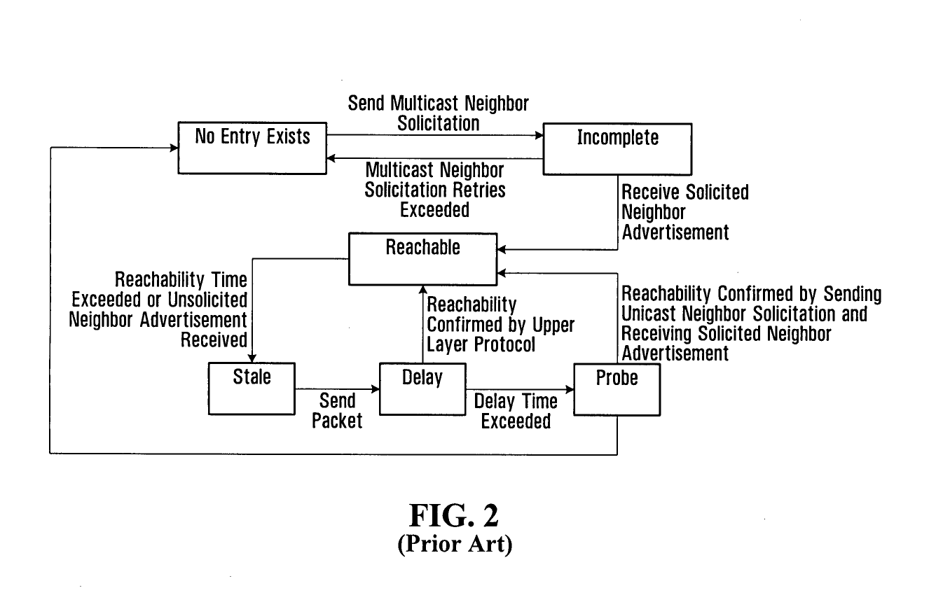

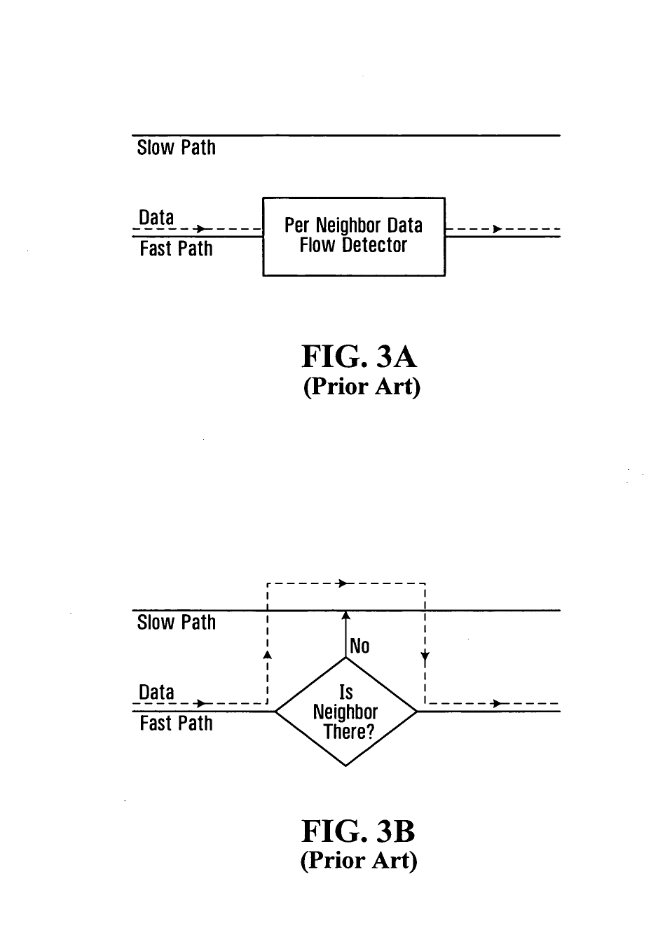

### DESCRIPTION OF THE EMBODIMENTS

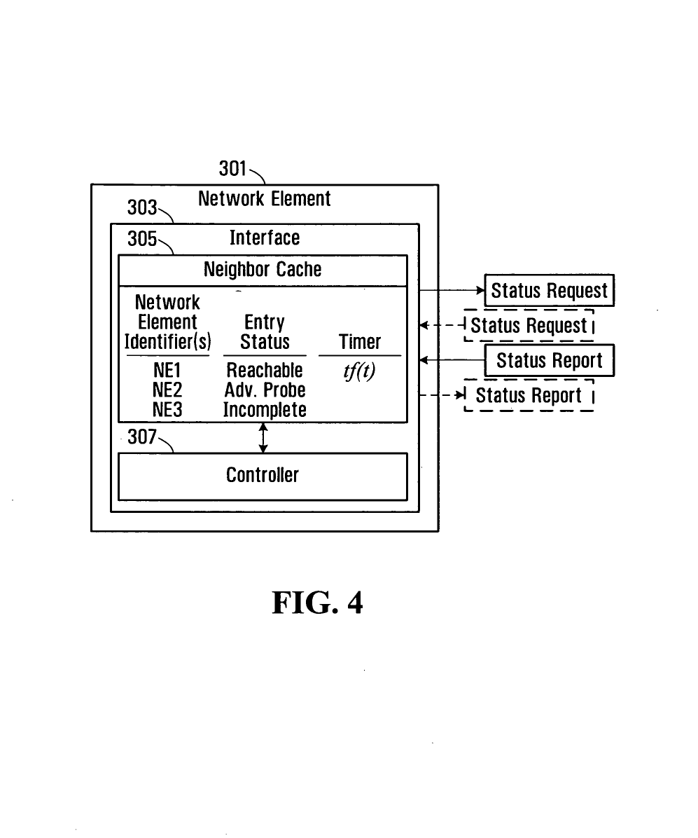

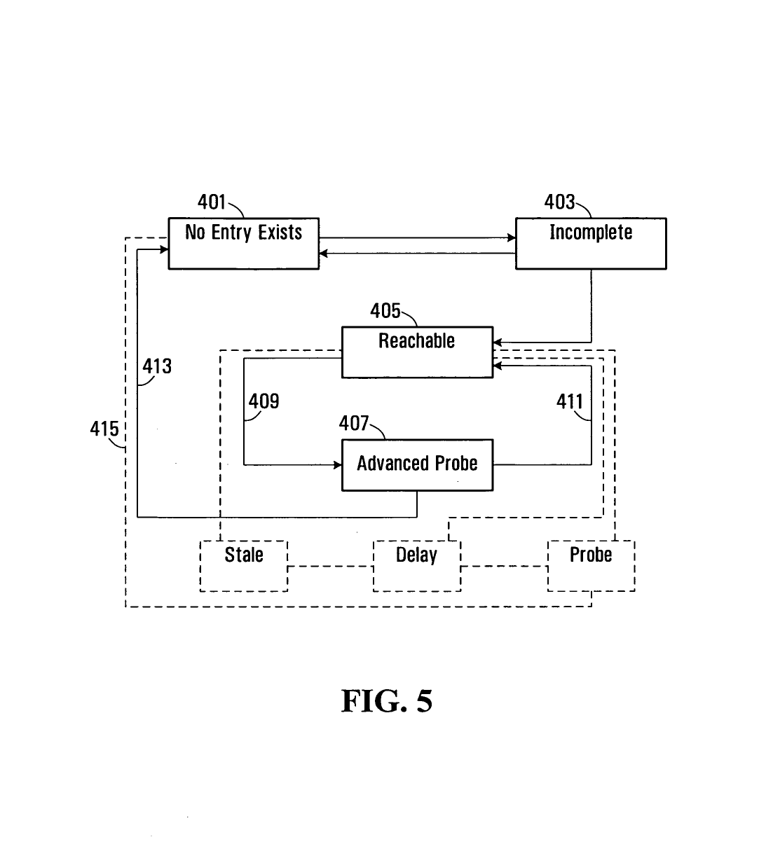

Referring to FIG. 4, a network element 301 according to an embodiment of the present invention comprises an interface 303 for transmitting and receiving communication signals to and from a communication network. The communication interface 303 includes a memory 305 which stores a record of information about neighboring network elements to which the interface is connected or with which the interface has previously communicated, and this record will be referred to as a “neighbor cache”. The neighbor cache includes one or more identifiers for identifying each neighbor network element, and the identifier(s) may include, for example, one or more addresses for each neighboring network element, such as unicast IP addresses. The neighbor cache may also include other information about each neighboring network element such as whether the network element is a host or router and other information which governs how the interface communicates with a neighbor. The neighbor cache also includes a status associated with each neighbor (or network element) entered in the record. Each status is described in more detail below with reference to FIG. 5.

The network element 301 further includes a controller 307 for controlling communications from the network element associated with neighbor discovery, and in accordance with the status associated with each neighbor network element indicated in the neighbor cache.

FIG. 5 shows an example of the various possible states for each entry in the neighbor cache and includes a “no entry exists” state 401, an “incomplete” state 403, a “reachable” state 405 and an “advanced probe” state 407.

When information about a neighbor for which no entry exists in the neighbor cache is to be discovered, the network element transmits a status request, for example, a multicast neighbor solicitation message, an entry for the neighbor is created in the neighbor cache, and an “incomplete” state is assigned to the new entry while the network element awaits a response from the neighbor, including its link-layer address. Multicast neighbor solicitation messages may be repeatedly sent a predetermined number of times, following which the address resolution process is abandoned.

On receiving a status report, for example, a unicast neighbor advertisement message from the neighbor, the entry status in the neighbor cache associated with the neighbor changes to the “reachable” state, and the entry status remains in this state for a period of time. In one implementation, as shown in FIG. 4, a timer is associated with each neighbor cache entry which records the time from which each neighbor was last confirmed as being reachable. On receiving a status report from the neighbor, the timer is set to a time value over which the neighbor is assumed to be reachable. This time value may be sent by the neighbor or may be a set value of the network element. The timer records the time which has elapsed since the status report confirming that the neighbor is reachable was received. If, before the time expires, the neighbor is confirmed to be reachable by some other means, for example, by other protocol(s), the timer may be reset to the original time value on each confirmation that the neighbor is reachable. If the time expires, the entry status changes to the “advanced probe” state 407 (as indicated by the arrow 409), in which the controller 307 (FIG. 4) causes transmission of a (further) status request to the neighbor. In one implementation, the status request is a neighbor solicitation message and may be transmitted as a unicast message.

If the neighbor responds by sending a status report confirming that it is still reachable, the entry status for the neighbor in the neighbor cache changes from “advanced probe” to the “reachable” state as indicated by the arrow 411 in FIG. 5.

On changing to the reachable state, the timer is set to the reachable time value and starts recording the elapsed time from when the last reachability confirmation was received. If the reachable time expires, the entry status again transitions from the reachable state to the advanced probe state, and a new status request is transmitted to the neighbor, and if reachability is confirmed, the cycle is repeated.

If during an “advanced probe” state, no message confirming reachability of the neighbor is received, the entry is deleted from the neighbor cache 305 so that the status transitions from the “advanced probe” state 407 to the “no entry exists” state 401 as indicated by arrow 413.

In this arrangement, each time the “reachable” state expires, the entry status changes directly to an “advanced probe” state which causes the network element to transmit a new status request addressed to the neighbor. Thus, each time the reachable state expires, the network element seeks confirmation from the neighbor that the neighbor is still reachable. In contrast to existing software solutions, this arrangement removes the need for capturing packets from the fast data path in the “stale” state, when the reachable state expires, so that data can continuously flow on the fast path without risk of packet reordering or packet loss resulting from a transition to the “stale” state.

Referring again to FIG. 5, in some embodiments, any one or more of the “stale”, “delay” and “probe” states, shown in broken lines may be omitted altogether or may be included as a selectable option. For example, the “stale”, “delay” and “probe” states may be used for neighbor cache entries which result from the network element learning information about a neighbor as a result of some exchange of information with the neighbor other than the receipt of a solicited neighbor advertisement message. For example, the network element may obtain information about a neighbor from a received status request (shown in broken lines in FIG. 4), e.g. a neighbor solicitation message, which includes, for example, the neighbor's source address. An entry for the neighbor may be created in the neighbor cache and a “stale” state assigned to the entry. When the network element is to initiate a new communication session with the neighbor, the network element sends one or more initial packets, and since the neighbor cache entry does not exist in the fast path, the first packet(s) is (are) extracted to the slow path to verify reachability. In the slow path, the controller changes the state from “stale” to “delay”, to allow the network element to determine from any other source, (e.g. higher layer protocol) whether the neighbor is reachable. If the neighbor is confirmed as reachable, the state of the entry changes to “reachable”. Otherwise, after a predetermined period of time set for the delay state, the state of the entry changes to the probe state in which the network element transmits a neighbor solicitation message to the neighbor. If a response confirming the neighbor's reachability is received, the entry changes from the “probe” state to the “reachable” state. Once in the “reachable” state (either through the “delay” or “probe” state) the controller programs the fast path with the resolved entry, and reinserts the packets from the slow path to the fast path. If on the other hand, no confirmation is received either in response to the first or any subsequent neighbor solicitation, the entry is deleted as indicated by arrow 415 from the “probe” state to the “no entry exists” state 401.

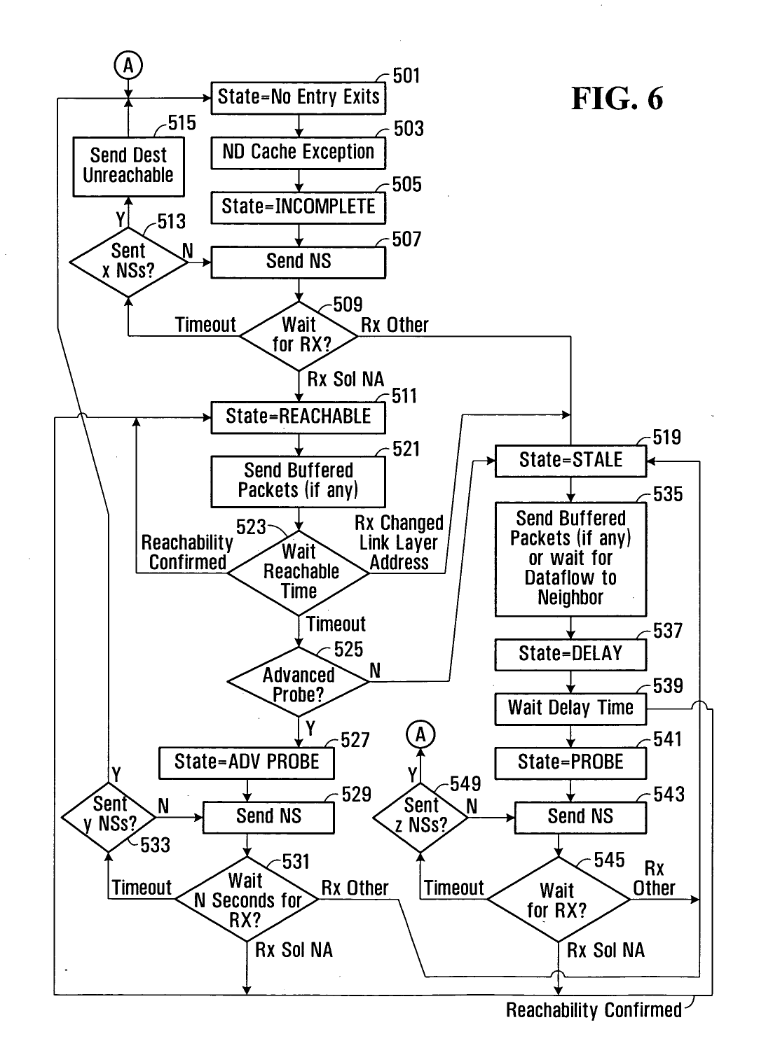

FIG. 6 shows a flow diagram illustrating an example of a method of monitoring status of a network element according to an embodiment of the present invention. The method starts at step 501 with a “No Entry Exists” state in which the neighbor-cache does not contain any entry for a particular neighbor. At step 505, a neighbor entry is created in the neighbor cache, and at step 507, a neighbor solicitation (NS) message is sent. At step 509, the process waits a predetermined length of time for a response to the neighbor solicitation and if a solicited neighbor advertisement (Sol NA) is received, the state of the entry changes from incomplete to “reachable” at step 511.

If, after the wait time at step 509, no response is received, the neighbor solicitation message is resent and a response awaited a further number of times until the number of neighbor solicitation messages reaches a set value, x, (which may have any value), and if no response is received after the last neighbor solicitation message is sent, the process passes to step 515 in which the destination to which the neighbor solicitation message is sent is determined as unreachable.

If at step 509, another message is received from the neighbor, the process passes to step 519, in which the entry changes from the “incomplete” state to the “stale” state and then any buffered data packets can be sent to the neighbor, as indicated at step 535.

Returning to step 511, when the entry is in the “reachable” state, any buffered data packets can be sent. The entry remains in the reachable state for the predetermined reachable time, as indicated by step 523, and once the time has expired, the process passes to step 525 where a decision is made as to whether the state of the entry should proceed to the “advanced probe” state at step, 527 or proceed to the “stale” state at step 519. If the “advanced probe” state is selected, a neighbor solicitation message is sent to the neighbor at step 529. The process waits for a response to the neighbor solicitation at step 531, and if a solicited neighbor advertisement is received, the state of the entry changes from “advanced probe” to “reachable” at step 511. On the other hand, if no solicited neighbor advertisement is received, nor any other indication that the neighbor is reachable, the neighbor solicitation message may be resent and a response awaited a certain number of times as indicated by step 533, where “y” can have any value. If, after the last attempt, no response is received, the entry is deleted and the process passes to the “No Entry Exists” state as indicated at step 501.

If instead of receiving a solicited neighbor advertisement in response to the neighbor solicitation, it is determined by other means (e.g. another message from the neighbor) that the neighbor is reachable, the entry changes from the “advanced probe” state to the “stale” state at step 519, the network element is enabled to send buffered data packets, if any, as indicated by step 535, and the state changes to “delay” at step 537.

In addition to the two routes to the “stale” state described above, the entry may also enter the “stale” state if, during the reachable state, the network element receives a notification from the neighbor that its link layer address has changed, or if a decision is made at step 525 that the “advanced probe” feature is not to be used. Once in the “stale” state (as reached through any of the routes described above, for example), the entry remains in the “stale” state until data is sent to the neighbor, as indicated by step 535. When data is sent, the entry then changes from the “stale” state to the “delay” state (for example by the mechanism described above where packets are sent to the slow path) and the entry remains in this state for a predetermined length of time as indicated at step 539, to provide an opportunity to determine whether the neighbor is reachable by any available means other than sending a neighbor solicitation message. If reachability is confirmed in the “delay” state, the entry changes to the “reachable” state 511. Otherwise, after the delay time, the state of the entry changes to the “probe” state at step 541, where the network element sends a neighbor solicitation message at step 543. The process then waits, at step 545, for a response to the neighbor solicitation message, and if a solicited neighbor advertisement is received, the state of the entry changes from “probe” to “reachable” at step 511. If no response is received within a predetermined wait time, the neighbor solicitation message may be resent a predetermined number of times, z, (which may have any value), after which if no response is received, the entry is deleted and the process passes to the “No Entry Exists” state 501. On the other hand, if during the wait time 545, it is determined that the neighbor is reachable by some means other than a solicited neighbor advertisement, the process proceeds to step 519, in which the state of the entry is changed to “stale” and then any buffered data packets can be sent at step 535.

The embodiment of FIG. 6 allows selection between a neighbor status monitoring process which involves the “advanced probe” state, and one which involves the “stale”, “delay” and “probe” states. Although the embodiment of FIG. 6 is described as using neighbor solicitations and neighbor advertisements as the status request and status report, respectively, it is to be noted that this embodiment may be implemented using any status request or report.

In other embodiments, the apparatus and method may be implemented to transmit a status request in the “reachable state”. In this case the “advanced probe” state is effectively included in or combined with the “reachable” state, so that a separate “advanced probe” state is unnecessary and can be omitted. For example, the “advanced probe” state of the embodiments of FIGS. 5 and 6 can be omitted, and the reachable state used instead to trigger the transmission of a status request.

Although some of the embodiments described above are concerned with monitoring the reachability status of a neighbor, other embodiments may alternatively, or in addition be implemented to monitor the status of one or more other attributes of a neighbor or other network resource.

Other aspects and embodiments of the present invention comprise any one or more features disclosed herein in combination with any one or more other features disclosed herein, an equivalent or variant thereof. In any aspects or embodiments of the present invention, any one or more features disclosed herein may be omitted altogether or substituted by an equivalent or variant thereof.

Numerous modifications and changes to the embodiments described above will be apparent to those skilled in the art.

1. An apparatus for monitoring status of a network element in a communication network, comprising:
transmission means for transmitting a status request,
receiving means for receiving a status report containing status information, and
a controller for controlling transmission of a status request at least one of (1) in response to the receipt of said status report, (2) during a time period when said status information contained in the received status report is deemed to be valid, and (3) in response to the expiry of said time period.

2. An apparatus as claimed in claim 1, wherein said status comprises a status indicative of whether said network element is reachable.

3. An apparatus as claimed in claim 1, wherein said controller is adapted to cause transmission of said status request a predetermined period of time after one of (1) said status report is received, and (2) a last indication is received confirming said status information contained in said status report.

4. An apparatus as claimed in claim 1, wherein said status request includes a request for the status of a predetermined attribute associated with the network element.

5. An apparatus as claimed in claim 1, wherein said transmission means is adapted to transmit said status request as a unicast transmission.

6. An apparatus as claimed in claim 1, wherein said transmission means is adapted to transmit a further status request subsequent to said status request according to a selected transmission mode depending on the response of said network element to said status request.

7. An apparatus as claimed in claim 6, wherein said transmission mode is a unicast transmission if a status report received in response to said status request indicates that the network element is reachable, and the transmission mode is a multicast transmission if it is determined that the network element, in response to said status request is unreachable.

8. An apparatus as claimed in claim 1, wherein said controller is adapted to cause said transmission means to transmit a status request in response to the receipt of each status report from said network element that is responsive to a previous status request and which indicates that the network element is reachable, and to transmit each status request at least one of (1) a predetermined period of time after the receipt of a respective status report, (2) during a time period when said status information is deemed to be valid, and (3) in response to the expiry of said time period.

9. An apparatus as claimed in claim 8, wherein said predetermined period of time is a time that said network element is assumed to be reachable.

10. An apparatus as claimed in claim 1, wherein said controller comprises a timer for measuring said predetermined time and which is activated by at least one of (1) the receipt of a status report indicating that the network element is reachable and (2) a determination that the network element is reachable.

11. An apparatus as claimed in claim 10, wherein said controller causes transmission of said status request immediately after the timer indicates that the predetermined period of time has expired.

12. An apparatus as claimed in claim 1, further comprising a memory for storing information about said network element and indicating means for indicating a state associated with said information, said indicating means indicating a state indicative of the network element being reachable in response to the receipt of a status report from said network element, and for indicating a state immediately after expiry of said time period indicative of the transmission of said status request.

13. A method of monitoring status of a network element in a communication network, comprising:
receiving a status report containing status information from said network element, and transmitting a status request to said network element at least one of (1) in response to the received report, (2) during a time period when said status information is deemed to be valid, and (3) in response to the expiry of said time period.

14. A method as claimed in claim 13, wherein said status indicates whether said network element is reachable.

15. A method as claimed in claim 13, wherein said status request is transmitted a predetermined time after one of (1) said status report is received, and (2) a last indication is received confirming said status information contained in said status report.

16. A method as claimed in claim 13, further comprising transmitting a further status request for said network element at least one of (1) in response to each receipt of a status report from said network element that is transmitted by said network element in response to a status request, (2) during a time period when said status information is deemed to be valid, and (3) in response to the expiry of said time period.

17. A method as claimed in claim 16, wherein each further status request is sent a predetermined period of time after (1) the receipt of a respective status report or (2) a determination that the status information is valid.

18. A method as claimed in claim 13, further comprising creating a record of the status of said network element in response to the receipt of said status report and during or in response to the expiry of said predetermined time period, assigning a state to said record, said state indicating the transmission of said status request.

19. A method as claimed in claim 13, further comprising enabling data to be transmitted to said network element while waiting for a response to said status request.

20. An apparatus for recording the status of a network element, comprising:
a recorder for entering an identification of said network element in a record, said recorder being responsive to a message from said network element to assign a first state to said record indicating that said network element is reachable, said recorder being responsive to said message and/or to the expiry of a time period following receipt of said message during which information in said message is deemed to be valid, to assign a second state to said record indicating that a status request is being sent to said network element.

21. An apparatus as claimed in claim 20, further comprising a controller for controlling transmission of said status request in response to detection of said second state.
